(19) United States
(12) Patent Application Publication
(10) Pub. No.: US 2025/0234061 A1
(43) Pub. Date: Jul. 17, 2025

(54) SCREEN MIRRORING METHOD AND SYSTEM, AND DEVICE AND STORAGE MEDIUM

(71) Applicant: Beijing Bytedance Network Technology Co., Ltd., Shijingshan District, Beijing (CN)

(72) Inventors: Guizhou WU, Beijing (CN); Hanyu ZHOU, Beijing (CN); Zhenhua YU, Beijing (CN)

(21) Appl. No.: 18/851,003

(22) PCT Filed: Mar. 14, 2023
(86) PCT No.: PCT/CN2023/081263

§ 371 Date: Sep. 25, 2024

(30) Foreign Application Priority Data
Apr. 8, 2022 (CN) 202210367043.8

(51) Int. Cl. H04N 21/436; H04N 21/41

(52) U.S. Cl. CPC H04N 21/436; H04N 21/4122

(57) ABSTRACT

A screen projection method and system, a device, and a storage medium are provided. The method includes: logging in to a screen projection server based on a set account; generating a push streaming address of at least one protocol type based on sending terminal information, and sending the push streaming address to the screen projection server, wherein the sending terminal information includes local area network address information, sending terminal port information, and audio and video path information; and sending an audio and video stream to a target receiving terminal based on the push streaming address, such that the target receiving terminal plays the audio and video stream, wherein the target receiving terminal is a terminal that logs in to the screen projection server with the set account.

The present application claims priority to Chinese Patent Application No. 202210367043.8, filed with the Chinese Patent Office on Apr. 8, 2022, which is incorporated herein by reference in its entirety.

### TECHNICAL FIELD

Embodiments of the present disclosure relate to the technical field of screen projection, e.g., to a screen projection method and system, a device, and a storage medium.

### BACKGROUND

Most screen projection methods in a related art are implemented based on private protocols or public protocols. Such protocols more or less have certain requirements on a sending terminal and a receiving terminal. Some protocols rely on hardware to a certain extent, while some protocols require purchase of a license, but can be used only on a specified system, which restricts the screen projection technology.

### SUMMARY

Embodiments of the present disclosure disclose a screen projection method and system, a device, and a storage medium, which can realize universality of screen projection and may not be limited by hardware and systems, etc.

### BRIEF DESCRIPTION OF DRAWINGS

FIG. 1 is a flowchart of a screen projection method in an embodiment of the present disclosure;

FIG. 2 is a flowchart of another screen projection method in an embodiment of the present disclosure;

FIG. 3 is a flowchart of another screen projection method in an embodiment of the present disclosure;

FIG. 4 is a structural schematic diagram of a screen projection system in an embodiment of the present disclosure; and

FIG. 5 is a structural schematic diagram of an electronic device in an embodiment of the present disclosure.

### DETAILED DESCRIPTION

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; The term “another embodiment” means “at least one other embodiment”; The term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “a” and “a plurality” mentioned in this disclosure are schematic rather than limiting, and those skilled in the art should understand that unless the context clearly indicates otherwise, they should be understood as “one or more”.

Names of messages or information exchanged among multiple devices in the embodiment of the present disclosure are only used for illustrative purposes, and are not used to limit the scope of these messages or information.

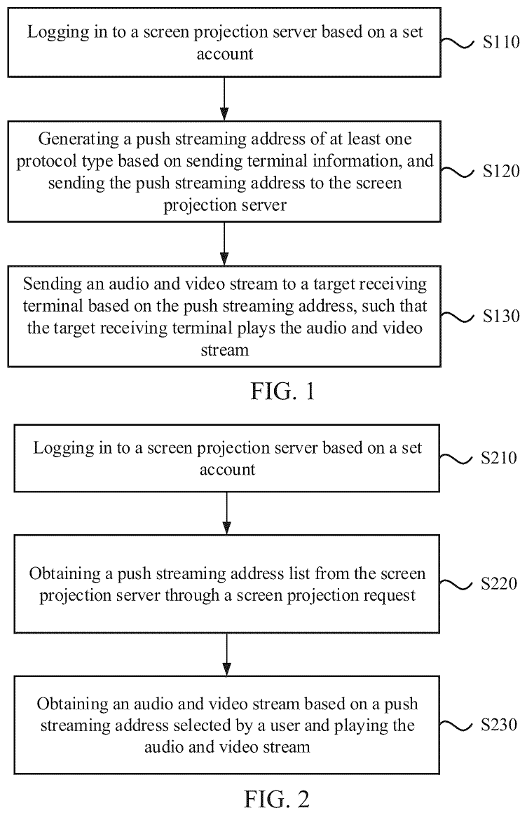

FIG. 1 is a flowchart of a screen projection method in an embodiment of the present disclosure. The present embodiment is applicable to a screen projection case. The screen projection method may be performed by a screen projection apparatus arranged at a sending terminal. The sending terminal may be a mobile terminal (e.g., a smart phone or a tablet platform) or a wearable device (e.g., a smart watch, a smart bracelet, smart glasses, a head-mounted VR terminal, etc.). As shown in FIG. 1, the screen projection method includes the following steps.

At S110, logging in to a screen projection server based on a set account.

The set account may be an account registered by a user in the screen projection server. The screen projection server may be construed as a server for realizing the screen projection function. In the present embodiment, the user logs in to the screen projection server by inputting the set account and a login password through a projection screen application (APP) installed on a sending terminal or a screen projection web page of a browser. After logging in to the screen projection server, the sending terminal may also report an address of a local area network in which the sending terminal resides to the screen projection server.

At S120, generating a push streaming address of at least one protocol type based on sending terminal information, and sending the push streaming address to the screen projection server.

The sending terminal information includes local area network address information, sending terminal port information, and audio and video path information. That is, the push streaming address consists of the local area network address information, the sending terminal port information, and the audio and video path information. The at least one protocol type may include a hyper text transfer protocol-flash video (HTTP-FLV) and a real time messaging protocol (RTMP). In this way, a receiving terminal supporting the HTTP-FLV or the RTMP may receive an audio and video stream from the sending terminal without being limited by hardware, systems, and the like.

For example, the sending terminal generates the push streaming address based on the obtained local area network address information, sending terminal port information, and audio and video path information, and sends the push streaming address to the screen projection server.

At S130, sending an audio and video stream to a target receiving terminal based on the push streaming address, such that the target receiving terminal plays the audio and video stream.

The target receiving terminal is a terminal that logs in to the screen projection server with the set account. That is, the target receiving terminal and the sending terminal log in to the screen projection server with the same account, and the target receiving terminal may be one or more target receiving terminals.

In this embodiment, if the target receiving terminal selects the push streaming address, then the sending terminal sends the audio and video stream to the target receiving terminal based on the push streaming address, such that the target receiving terminal plays the audio and video stream. Thus, it is realized that the sending terminal projects the audio and video stream to the target receiving terminal.

For example, a process of sending the audio and video stream to the target receiving terminal based on the push streaming address may include: performing a screen recording operation on the sending terminal to obtain the audio and video stream; determining whether the sending terminal and the target receiving terminal are in a same local area network; establishing a data channel with the target receiving terminal according to the push streaming address, based on a determination result that the sending terminal and the target receiving terminal are in the same local area network, and sending the audio and video stream to the target receiving terminal through the data channel; and sending the audio and video stream to the screen projection server based on a determination result that the sending terminal and the target receiving terminal are not in the same local area network, such that the screen projection server forwards the audio and video stream to the target receiving terminal.

The screen recording operation may be construed as recording an audio and video played on a current screen to obtain the audio and video stream.

A way of determining whether the sending terminal and the target receiving terminal are in the same local area network may include: sending network exploration (ping) information to the target receiving terminal; and determining that the sending terminal and the target receiving terminal are in the same local area network in response to receiving feedback information from the target receiving terminal.

In this embodiment, after the sending terminal logs in to the screen projection server, the screen projection server sends a ping instruction to the sending terminal, and the sending terminal pings the receiving terminal according to the ping instruction. If the feedback information from the target receiving terminal is received, the sending terminal and the target receiving terminal are in the same local area network.

In this embodiment, if the sending terminal and the target receiving terminal are in the same local area network, then the sending terminal sends the audio and video stream to the target receiving terminal through the established data channel; and if the sending terminal and the target receiving terminal are not in the same local area network, then the sending terminal sends the audio and video stream to the screen projection server such that the screen projection server forwards the audio and video stream to the target receiving terminal.

According to the technical solution of this embodiment of the present disclosure, logging in to a screen projection server based on a set account; generating a push streaming address of at least one protocol type based on sending terminal information, and sending the push streaming address to the screen projection server, wherein the sending terminal information comprises local area network address information, sending terminal port information, and audio and video path information; and sending an audio and video stream to a target receiving terminal based on the push streaming address, such that the target receiving terminal plays the audio and video stream. The screen projection method provided in this embodiment of the present disclosure can realize universality of screen projection and may not be limited by hardware and systems, etc.

FIG. 2 is a flowchart of a screen projection method in an embodiment of the present disclosure. On the basis of the above embodiment, this embodiment is applicable to a screen projection case. The screen projection method may be performed by a screen projection apparatus arranged at a receiving terminal. The receiving terminal may be a mobile terminal (e.g., a smart phone or a tablet platform) or a wearable device (e.g., a smart watch, a smart bracelet, smart glasses, a head-mounted VR terminal, etc.). As shown in FIG. 1, the screen projection method includes the following steps.

At S210, logging in to a screen projection server based on a set account.

The set account may be an account registered by a user on the screen projection server. The screen projection server may be construed as a server for realizing the screen projection function. In this embodiment, the user logs in to the screen projection server by inputting the set account and a login password through a projection screen application (APP) installed on a sending terminal or a screen projection web page of a browser. After logging in to the screen projection server, the receiving terminal may also report an address of a local area network in which the receiving terminal resides to the screen projection server.

At S220, obtaining a push streaming address list from the screen projection server through a screen projection request.

The push streaming address is generated using a terminal that logs in to the screen projection server with the set account. The screen projection request may be sent through the browser web page or the screen projection APP.

In this embodiment, a process of obtaining the push streaming address list from the screen projection server through the screen projection request may include: sending the screen projection request to the screen projection server through a set screen projection website address in response to determining that the receiving terminal logs in to the screen projection server through a web page, to obtain the push streaming address list.

The set screen projection website address may be a preset address, e.g., http://www.touping.com. In this embodiment, after receiving the screen projection request, the screen projection server determines a communication protocol supported by the receiving terminal and sends the push streaming address list under the communication protocol supported by the receiving terminal corresponding to the same account to the receiving terminal. Thus, the receiving terminal selects one push streaming address from the push streaming address list to obtain the audio and video stream corresponding to the push streaming address. That is, if the receiving terminal supports the HTTP-FLV, the screen projection server sends the push streaming address list under the HTTP-FLV to the receiving terminal. If the receiving terminal supports the RTMP, the screen projection server sends the push streaming address list under the RTMP to the receiving terminal.

For example, if the receiving terminal logs in to the screen projection server through the screen projection APP, a screen projection request module triggered by the user is detected to send the screen projection request to the screen projection server with the push streaming address list to obtain the push streaming address list.

At S230, obtaining an audio and video stream based on a push streaming address selected by a user and playing the audio and video stream.

For example, the user selects one push streaming address from the push streaming address list, obtains the audio and video stream corresponding to the sending terminal which corresponding to the push streaming address, and plays the audio and video stream.

For example, a way of obtaining the audio and video stream based on the push streaming address selected by the user and playing the audio and video stream may include: determining a target sending terminal based on the push streaming address selected by the user; receiving the audio and video stream sent by the target sending terminal in response to determining that the receiving terminal and the target sending terminal are in a same local area network; and receiving the audio and video stream sent by the screen projection server in response to determining that the receiving terminal and the target sending terminal are in different local area networks.

In this embodiment, after the user selects one push streaming address, the sending terminal which generated the push streaming address is determined as the target sending terminal. If the receiving terminal and the target sending terminal are in the same local area network, the audio and video stream sent by the target sending terminal through a data channel is received, and if the receiving terminal and the target sending terminal are in different local area networks, the audio and video stream forwarded by the screen projection server is received.

According to the technical solution of this embodiment of the present disclosure, logging in to a screen projection server based on a set account; obtaining a push streaming address list from the screen projection server through a screen projection request, wherein a push streaming address is generated by a sending terminal that logs in to the screen projection server with the set account; and obtaining an audio and video stream based on a push streaming address selected by a user and playing the audio and video stream. The screen projection method provided in this embodiment of the present disclosure can realize universality of screen projection and may not be limited by hardware and systems, etc.

FIG. 3 is a flowchart of a screen projection method in an embodiment of the present disclosure. On the basis of the above embodiments, this embodiment is applicable to a screen projection case. The screen projection method may be performed by a screen projection apparatus arranged at a screen projection server. As shown in FIG. 3, the screen projection method includes the following steps.

At S410, receiving a push streaming address sent by a sending terminal and a screen projection request sent by at least one receiving terminal when it is detected that the sending terminal and the at least one receiving terminal log in to the screen projection server based on a same set account.

At S420, sending the push streaming address to the at least one receiving terminal based on the screen projection request, such that the sending terminal projects an audio and video stream played to the at least one receiving terminal for playing.

In this embodiment, when the sending terminal logs in to the screen projection server based on the set account, the push streaming address of at least one protocol type is generated based on sending terminal information, and the push streaming address is sent to the screen projection server. When the receiving terminal logs in to the screen projection server based on the same set account, the receiving terminal sends the screen projection request to the screen projection server. The server sends the push streaming address to the at least one sending terminal based on the screen projection request, such that the sending terminal projects the played audio and video stream to the at least one receiving terminal for playing.

For example, after receiving the push streaming address sent by the sending terminal and the screen projection request sent by the at least one receiving terminal, the screen projection method further includes: forwarding the audio and video stream to the at least one receiving terminal for playing in response to receiving the audio and video stream sent by the sending terminal.

In this embodiment, if the receiving terminal and the sending terminal are not in the same local area network, the sending terminal sends the recorded audio and video stream to the screen projection server, such that the screen projection server forwards the audio and video stream to the receiving terminal.

According to the technical solution of this embodiment, receiving a push streaming address sent by a sending terminal and a screen projection request sent by at least one receiving terminal when it is detected that the sending terminal and the at least one receiving terminal log in to the screen projection server based on a same set account; and sending the push streaming address to the at least one receiving terminal based on the screen projection request, such that the sending terminal projects an audio and video stream played to the at least one receiving terminal for playing. The screen projection method can realize universality of screen projection and may not be limited by hardware and systems, etc.

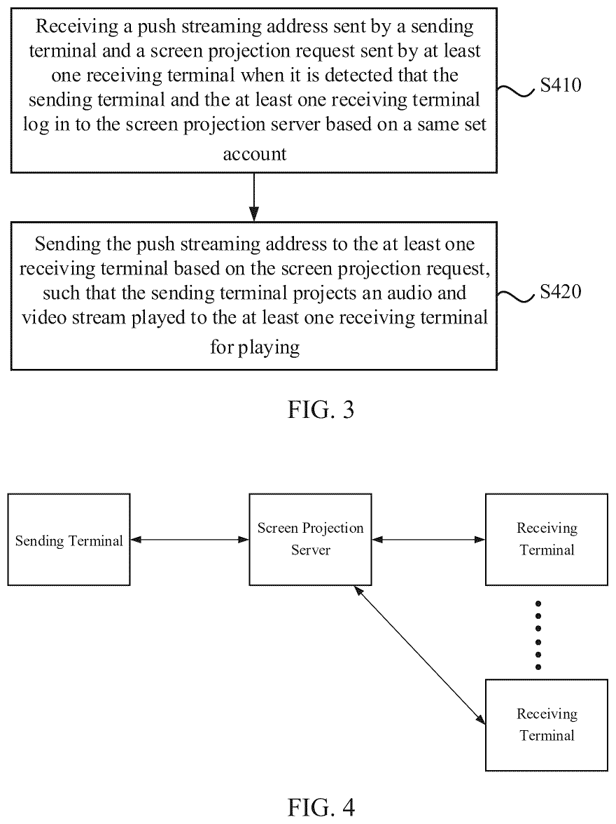

FIG. 4 is a structural schematic diagram of a screen projection system in an embodiment of the present disclosure. As shown in FIG. 4, the screen projection system includes a sending terminal, a screen projection server, and at least one receiving terminal. The sending terminal and the at least one receiving terminal log in to the screen projection server based on a same set account. The sending terminal is configured to a push streaming address generated to the screen projection server. The at least one receiving terminal is configured to send a screen projection request to the screen projection server, and the screen projection server is configured to send the push streaming address to the at least one receiving terminal based on the screen projection request. The sending terminal is further configured to project, based on the push streaming address, an audio and video stream to the at least one receiving terminal for playing.

The principle of the screen projection system is as follows:
1) The sending terminal logs in to the screen projection server with the set account and sends a local area network address to the screen projection server at the same time.
2) The receiving terminal logs in to the screen projection server with the same set account and sends a local area network address to the screen projection server at the same time.
3) The screen projection server detects the sending terminal and the receiving terminal logging in with the same set account and sends a ping instruction to the sending terminal.
4) The sending terminal pings the receiving terminal based on the ping instruction. If pinging is successful, the receiving terminal and the sending terminal are in the same local area network. If pinging is failed, the receiving terminal and the sending terminal are not in the same local area network.
5) The sending terminal generates a push streaming address and sends the push streaming address to the screen projection server.
6) The receiving terminal inputs the address “http://www.touping.com” through a web page to send the screen projection request to the screen projection server.
7) The screen projection server sends a push streaming address list to receiving terminal based on the screen projection request.
8) The receiving terminal receives a push streaming address selected by a user from the push streaming address list.
9) The receiving terminal initiates a screen recording operation to obtain an audio and video stream. If the receiving terminal and the sending terminal are in the same local area network, the audio and video stream is sent to the receiving terminal through an established data channel. If the receiving terminal and the sending terminal are not in the same local area network, the audio and video stream is sent to the screen projection server, such that the screen projection server forwards it to the receiving terminal.
10) The receiving terminal plays the received audio and video stream, thereby realizing screen projection.

The screen projection system disclosed in this embodiment of the present disclosure includes the sending terminal, the screen projection server, and the at least one receiving terminal. The sending terminal and the at least one receiving terminal log in to the screen projection server based on a same set account. The sending terminal is configured to a push streaming address generated to the screen projection server. The at least one receiving terminal is configured to send a screen projection request to the screen projection server, and the screen projection server is configured to send the push streaming address to the at least one receiving terminal based on the screen projection request. The sending terminal is further configured to project, based on the push streaming address, an audio and video stream to the at least one receiving terminal for playing. The screen projection system can realize universality of screen projection and may not be limited by hardware and systems, etc.

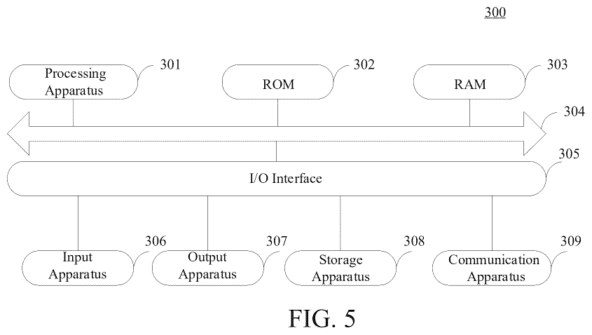

Referring to FIG. 5, FIG. 5 illustrates a schematic structural diagram of an electronic device 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 300 may include a processing apparatus 301 (e.g., a central processing unit, a graphics processing unit, etc.), which can perform various suitable actions and processing according to a program stored in a read-only memory (ROM) 302 or a program loaded from a storage apparatus 308 into a random-access memory (RAM) 303. The RAM 303 further stores various programs and data required for operations of the electronic device 300. The processing apparatus 301, the ROM 302, and the RAM 303 are interconnected by means of a bus 304. An input/output (I/O) interface 305 is also connected to the bus 304.

Usually, the following apparatus may be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 5 illustrates the electronic device 300 having various apparatuses, it should be understood that not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 309 and installed, or may be installed from the storage apparatus 308, or may be installed from the ROM 302. When the computer program is executed by the processing apparatus 301, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The computer-readable medium carries one or more programs which, when executed by the electronic device, cause the electronic device to: log in to a screen projection server based on a set account; generate a push streaming address of at least one protocol type based on sending terminal information, and send the push streaming address to the screen projection server, wherein the sending terminal information comprises local area network address information, sending terminal port information, and audio and video path information; and send an audio and video stream to a target receiving terminal based on the push streaming address, such that the target receiving terminal plays the audio and video stream, wherein the target receiving terminal is a terminal that logs in to the screen projection server with the set account; or, log in to a screen projection server based on a set account; obtain a push streaming address list from the screen projection server through a screen projection request, wherein a push streaming address is generated by a sending terminal that logs in to the screen projection server with the set account; and obtain an audio and video stream based on a push streaming address selected by a user and play the audio and video stream; or, receive a push streaming address sent by a sending terminal and a screen projection request sent by at least one receiving terminal when it is detected that the sending terminal and the at least one receiving terminal log in to the screen projection server based on a same set account; and send the push streaming address to the at least one receiving terminal based on the screen projection request, such that the sending terminal projects an audio and video stream played to the at least one receiving terminal for playing

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

An embodiment of the present disclosure discloses a screen projection method, performed by a sending terminal and including:
logging in to a screen projection server based on a set account;
generating a push streaming address of at least one protocol type based on sending terminal information, and sending the push streaming address to the screen projection server, wherein the sending terminal information comprises local area network address information, sending terminal port information, and audio and video path information; and
sending an audio and video stream to a target receiving terminal based on the push streaming address, such that the target receiving terminal plays the audio and video stream, wherein the target receiving terminal is a terminal that logs in to the screen projection server with the set account.

In an embodiment, sending the audio and video stream to the target receiving terminal based on the push streaming address includes:
performing a screen recording operation on the sending terminal to obtain the audio and video stream;
determining whether the sending terminal and the target receiving terminal are in a same local area network;
establishing a data channel with the target receiving terminal according to the push streaming address, based on a determination result that the sending terminal and the target receiving terminal are in the same local area network, and sending the audio and video stream to the target receiving terminal through the data channel; and
sending the audio and video stream to the screen projection server based on a determination result that the sending terminal and the target receiving terminal are not in the same local area network, such that the screen projection server forwards the audio and video stream to the target receiving terminal.

In an embodiment, determining whether the sending terminal and the target receiving terminal are in the same local area network includes:
sending network exploration (ping) information to the target receiving terminal; and
determining that the sending terminal and the target receiving terminal are in the same local area network in response to receiving feedback information from the target receiving terminal.

An embodiment of the present disclosure further provides a screen projection method, performed by a receiving terminal and including:
logging in to a screen projection server based on a set account;
obtaining a push streaming address list from the screen projection server through a screen projection request, wherein a push streaming address is generated by a sending terminal that logs in to the screen projection server with the set account; and
obtaining an audio and video stream based on a push streaming address selected by a user and playing the audio and video stream.

In an embodiment, obtaining the push streaming address list from the screen projection server through the screen projection request includes:
sending the screen projection request to the screen projection server through a set screen projection website address in response to determining that the receiving terminal logs in to the screen projection server through a web page, to obtain the push streaming address list.

In an embodiment, obtaining the audio and video stream based on the push streaming address selected by the user and playing the audio and video stream include:
determining a target sending terminal based on the push streaming address selected by the user;
receiving the audio and video stream sent by the target sending terminal in response to determining that the receiving terminal and the target sending terminal are in a same local area network; and
receiving the audio and video stream sent by the screen projection server in response to determining that the receiving terminal and the target sending terminal are in different local area networks.

An embodiment of the present disclosure discloses a screen projection method, performed by a screen projection server and including:
receiving a push streaming address sent by a sending terminal and a screen projection request sent by at least one receiving terminal when it is detected that the sending terminal and the at least one receiving terminal log in to the screen projection server based on a same set account; and
sending the push streaming address to the at least one receiving terminal based on the screen projection request, such that the sending terminal projects an audio and video stream played to the at least one receiving terminal for playing.

In an embodiment, after receiving the push streaming address sent by the sending terminal and the screen projection request sent by the at least one receiving terminal, further includes:

forwarding the audio and video stream to the at least one receiving terminal for playing in response to receiving the audio and video stream sent by the sending terminal.

An embodiment of the present disclosure discloses a screen projection system, including a sending terminal, a screen projection server, and at least one receiving terminal.
wherein the sending terminal is configured to: log in to the screen projection server based on a same set account; send a push streaming address generated to the screen projection server; and project, based on the push streaming address, an audio and video stream to the at least one receiving terminal for playing;
the screen projection server is configured to: send the push streaming address to the at least one receiving terminal based on a screen projection request; and
the at least one receiving terminal is configured to: log in to the screen projection server based on the same set account; and send the screen projection request to the screen projection server.

What is claimed is:

1. A screen projection method, performed by a sending terminal, comprising:
logging in to a screen projection server based on a set account;
generating a push streaming address of at least one protocol type based on sending terminal information, and sending the push streaming address to the screen projection server, wherein the sending terminal information comprises local area network address information, sending terminal port information, and audio and video path information; and
sending an audio and video stream to a target receiving terminal based on the push streaming address, such that the target receiving terminal plays the audio and video stream, wherein the target receiving terminal is a terminal that logs in to the screen projection server with the set account.

2. The method according to claim 1, wherein sending the audio and video stream to the target receiving terminal based on the push streaming address comprises:
performing a screen recording operation on the sending terminal to obtain the audio and video stream;
determining whether the sending terminal and the target receiving terminal are in a same local area network;
establishing a data channel with the target receiving terminal according to the push streaming address, based on a determination result that the sending terminal and the target receiving terminal are in the same local area network, and sending the audio and video stream to the target receiving terminal through the data channel; and
sending the audio and video stream to the screen projection server based on a determination result that the sending terminal and the target receiving terminal are not in the same local area network, such that the screen projection server forwards the audio and video stream to the target receiving terminal.

3. The method according to claim 2, wherein determining whether the sending terminal and the target receiving terminal are in the same local area network comprises:
sending network exploration (ping) information to the target receiving terminal; and
determining that the sending terminal and the target receiving terminal are in the same local area network in response to receiving feedback information from the target receiving terminal.

4. A screen projection method, performed by a receiving terminal, comprising:
logging in to a screen projection server based on a set account;
obtaining a push streaming address list from the screen projection server through a screen projection request, wherein a push streaming address is generated by a sending terminal that logs in to the screen projection server with the set account; and
obtaining an audio and video stream based on a push streaming address selected by a user and playing the audio and video stream.

5. The method according to claim 4, wherein obtaining the push streaming address list from the screen projection server through the screen projection request comprises:
sending the screen projection request to the screen projection server through a set screen projection website address in response to determining that the receiving terminal logs in to the screen projection server through a web page, to obtain the push streaming address list.

6. The method according to claim 4, wherein obtaining the audio and video stream based on the push streaming address selected by the user and playing the audio and video stream comprises:
determining a target sending terminal based on the push streaming address selected by the user;
receiving the audio and video stream sent by the target sending terminal in response to determining that the receiving terminal and the target sending terminal are in a same local area network; and
receiving the audio and video stream sent by the screen projection server in response to determining that the receiving terminal and the target sending terminal are in different local area networks.

7. A screen projection method, performed by a screen projection server, comprising:
receiving a push streaming address sent by a sending terminal and a screen projection request sent by at least one receiving terminal when it is detected that the sending terminal and the at least one receiving terminal log in to the screen projection server based on a same set account; and
sending the push streaming address to the at least one receiving terminal based on the screen projection request, such that the sending terminal projects an audio and video stream played to the at least one receiving terminal for playing.

8. The method according to claim 7, after receiving the push streaming address sent by the sending terminal and the screen projection request sent by the at least one receiving terminal, further comprising:
forwarding the audio and video stream to the at least one receiving terminal for playing in response to receiving the audio and video stream sent by the sending terminal.

9. A screen projection system, comprising a sending terminal, a screen projection server, and at least one receiving terminal,
wherein the sending terminal is configured to perform the screen projection method according to claim 1;
the screen projection server is configured to: send the push streaming address to the at least one receiving terminal based on a screen projection request; and
the at least one receiving terminal is configured to: log in to the screen projection server based on the same set account; and send the screen projection request to the screen projection server.

10. An electronic device, comprising:
at least a processor, and
a non-transitory memory with instructions thereon,
wherein the instructions upon execution by the processor, cause the processor to implement the screen projection method according to claim 1.

11. A non-transitory computer-readable storage medium, storing a computer program, wherein the computer program, when executed by a processor, the processor implements the screen projection method according to claim 1.

12. The electronic device according to claim 10, the processor is further caused to:
perform a screen recording operation on the sending terminal to obtain the audio and video stream;
determine whether the sending terminal and the target receiving terminal are in a same local area network;
establish a data channel with the target receiving terminal according to the push streaming address, based on a determination result that the sending terminal and the target receiving terminal are in the same local area network, and send the audio and video stream to the target receiving terminal through the data channel; and
send the audio and video stream to the screen projection server based on a determination result that the sending terminal and the target receiving terminal are not in the same local area network, such that the screen projection server forwards the audio and video stream to the target receiving terminal.

13. The electronic device according to claim 10, the processor is further caused to:
send network exploration (ping) information to the target receiving terminal; and
determine that the sending terminal and the target receiving terminal are in the same local area network in response to receiving feedback information from the target receiving terminal.

14. The non-transitory computer-readable storage medium according to claim 11, the processor further to:
perform a screen recording operation on the sending terminal to obtain the audio and video stream;
determine whether the sending terminal and the target receiving terminal are in a same local area network;
establish a data channel with the target receiving terminal according to the push streaming address, based on a determination result that the sending terminal and the target receiving terminal are in the same local area network, and send the audio and video stream to the target receiving terminal through the data channel; and
send the audio and video stream to the screen projection server based on a determination result that the sending terminal and the target receiving terminal are not in the same local area network, such that the screen projection server forwards the audio and video stream to the target receiving terminal.

15. The non-transitory computer-readable storage medium according to claim 11, the processor further to:
send network exploration (ping) information to the target receiving terminal; and
determine that the sending terminal and the target receiving terminal are in the same local area network in response to receiving feedback information from the target receiving terminal.

16. An electronic device, comprising:
at least a processor, and
a non-transitory memory with instructions thereon,
wherein the instructions upon execution by the processor, cause the processor to implement the screen projection method according to claim 4.

17. An electronic device, comprising:
at least a processor, and
a non-transitory memory with instructions thereon,
wherein the instructions upon execution by the processor, cause the processor to implement the screen projection method according to claim 7.

18. The electronic device according to claim 17, the processor is further caused to:
forward the audio and video stream to the at least one receiving terminal for playing in response to receiving the audio and video stream sent by the sending terminal.

19. The non-transitory computer-readable storage medium, storing a computer program, wherein the computer program, when executed by a processor, the processor implements the screen projection method according to claim 4.

20. The non-transitory computer-readable storage medium, storing a computer program, wherein the computer program, when executed by a processor, the processor implements the screen projection method according to claim 7.
